(19) United States
(12) Patent Application Publication
(10) Pub. No.: US 2013/0065726 A1
(43) Pub. Date: Mar. 14, 2013

(54) CONTINUOUSLY VARIABLE TORQUE TRANSMISSION DEVICE

(71) Applicant: Viktor Alexandrovich Khonin, Kaliningradskaya obl. (RU)

(72) Inventor: Viktor Alexandrovich Khonin, Kaliningradskaya obl. (RU)

(21) Appl. No.: 13/698,351

(22) PCT Filed: May 19, 2011
(86) PCT No.: PCT/RU2011/000339

§ 371 Date: Nov. 16, 2012

(30) Foreign Application Priority Data
May 20, 2010 (RU) 2010120105

(51) Int. Cl. F16H 37/08

(52) U.S. Cl. 475/198

(57) ABSTRACT

The continuously variable torque transmission device relates to the field of mechanical engineering. The device comprises a mobile mechanism of flexible brakes for gears that functions as a regulating unit having a base located on guides rigidly secured to a housing. The shafts of two spur wheels are secured in the base the spur wheels being engaged with each other and one of the spur wheels contacting the most mobile spur wheel which engages with a wheel seated on a countershaft. The shafts of these wheels are connected to each other by mobile intermediate plates. The other spur wheel contacts the other most mobile spur wheel which engages with a wheel seated on a drive shaft. The shafts of these pairs of wheels are connected to each other by mobile intermediate plates. The shafts of the mobile wheels are connected to each other by tension springs. Compression springs are mounted on guides between the housing and the base of the mobile mechanism of flexible brakes. The guides have limiters. The technical result is an improvement in technical characteristics.

### FIELD OF THE INVENTION

The claimed device relates to the field of mechanical engineering and may be used for continuously varying the speed of shaft rotation and torque.

### BACKGROUND OF THE INVENTION

A prior art invention, for example, a bevel friction gear having parallel shafts (see: I. I. Markhel, “Machine Components,” Mashinostroenie Publishers, 1977, Chapter 2, page 35, FIG. 2.6) comprises a drive shaft having a cone secured thereon, a driven shaft that is parallel to the drive shaft and has a cone secured thereon at a taper angle equal to the taper angle of the drive shaft such that the cone vertexes face in the opposite directions, and a friction roller secured on its shaft extending in parallel to the working surfaces of the cones at the middle point thereof in a plane extending across the axis of symmetry of the shafts.

The friction roller engages the working surfaces of the cones and extends at right angles thereto. As the drive cone rotates the forces of friction between the working surface of the cone and friction roller cause rotation of the roller that is in engagement with the surface of the driven roller and rotates the driven cone by the forces of friction between the roller and the surface of the driven roller. The friction roller can move on its shaft over the surfaces of the cones and, therefore, change the gear ratio of the transmission because a cone has different diameters at different points of its cross-section, and as the roller moves to different areas of the cone it alters the ratio of the diameters of the drive and driven cones at the point of contact thereof with the friction roller.

An advantage of a friction engagement gear is that it can change the gear ratios smoothly.

Disadvantages of a friction engagement gear are the insignificant power transmitted and low wear resistance.

Transmission of rotation from a drive shaft to a driven shaft by continuously changing the rotation speed of the driven shaft is a characteristic shared by the claimed invention and the prior art device described above.

This gear is disadvantageous because it cannot transmit rotation from a drive shaft to a driven shaft by normal engagement forces.

The reason why a favorable technical result cannot be attained is that this device is designed to transmit rotation from the drive shaft to the driven shaft by friction.

Another prior art mechanical engagement gear for transmitting rotation at variable gear ratios (see: description of Russian Patent No. 2154759) comprises a rotation transmitting unit, and a drive and driven cones. The rotation transmitting unit comprises a drive cone pinion, a central gear, and a driven cone pinion. Rotation is transmitted through hemispherical projections provided on the pinions and hemispherical recesses in the cones. The hemispherical recesses and projections are provided at an identical distance from one another on the surface of forming members. The gear allows smooth variation of the gear ratios for transmitting the torque from one shaft to the other by mechanical engagement.

This gear is disadvantageous because the insignificant power it transmits cannot transmit torque by gearing.

Still another continuously variable transmission device (RU No. 2151935, F16H 3/42 of May 6, 1998) comprises a drive and driven shafts, a cylinder having an axis of rotation that coincides with the axis of rotation of the drive shaft located inside the cylinder, U-shaped plates of equal length placed in the radial slots of the drive shaft for reciprocation, the plates engaging one another by their slots and having their ends in engagement with the inner surface of the cylinder; rollers provided on the projecting ends of the plates, and teeth hinged to one another into an endless belt sliding over the surface of a profiled member having a cross-section similar to the cross-section of the cylinder, the outer teeth of the endless belt engaging the rollers, and the inner teeth engaging the driven shaft.

This prior art gear has the following deficiencies:
it does not transmit torque through the gearing;
it has a low load-transmitting capacity;
it is not reliable enough in operation; and
it has a low efficiency.

### SUMMARY OF THE INVENTION

According to the idea of the claimed invention, the continuously variable torque transmission device comprising a housing, a drive and driven shafts, a countershaft, and an auxiliary shaft is distinct from the closest prior art devices because a gear is securely fitted on the drive shaft and a shaft of differential pinions is provided normally to the drive shaft and has two bevel wheels fitted at the ends thereof in engagement with a pair of bevel wheels, one of which is connected rigidly to a spur wheel and the other bevel wheel that has gear rings at both ends thereof is rigidly fitted on the driven shaft, the driven shaft having a spur wheel freely fitted thereon and also serving as the shaft of the differential pinions having two bevel wheels fitted thereon in engagement with the pair of bevel wheels, one of which is a bevel wheel having two gear rings and the other being rigidly connected to the large-diameter spur wheel; the countershaft having a spur wheel fitted rigidly thereon in engagement with a gear, the shaft of the differential pinions and a small-diameter spur pinion normally to the shaft; the ends of the shaft of the differential pinions being provided with two bevel pinions in engagement with a pair of bevel pinions, one of which is connected rigidly to the spur wheel that engages, through a mobile mechanism of flexible brakes of the pinions, a similar wheel fitted on the drive shaft, the other is connected rigidly to the spur wheel in engagement with the pinion serving as the shaft of the differential pinions; the auxiliary shaft having two spur wheels secured rigidly thereon, in particular, a small-diameter wheel in engagement with a large-diameter wheel fitted on the driven shaft, and a large-diameter wheel engaging a small-diameter wheel and fitted on the countershaft; the mobile mechanism of flexible brakes for the gearwheels having a base provided on guides secured rigidly to the housing; the base having the shafts of two spur wheels secured therein in engagement with each other, one of them being in engagement with the most mobile spur wheel that is in engagement with the wheel fitted on the countershaft, the shafts of said wheels being connected with one another by mobile intermediate plates; the other spur wheel engaging the other most mobile spur wheel that is, in turn, in engagement with the wheel fitted on the drive shaft, and the shafts of these pairs of wheels being also connected with one another by mobile intermediate plates; the shafts of the most mobile wheels being connected with one another by tension springs; compression springs being provided on the guides between the housing and the base of the mobile mechanism of flexible brakes; and the guides being provided with limiters.

The technical result of the present invention consists in continuous variation of the gear ratios for transmission of the torque from one shaft to the other through mechanical engagement.

### BRIEF DESCRIPTION OF THE DRAWINGS

The idea of the invention will be clear from the following description and drawings:

FIG. 1 is a functional diagram of the device;

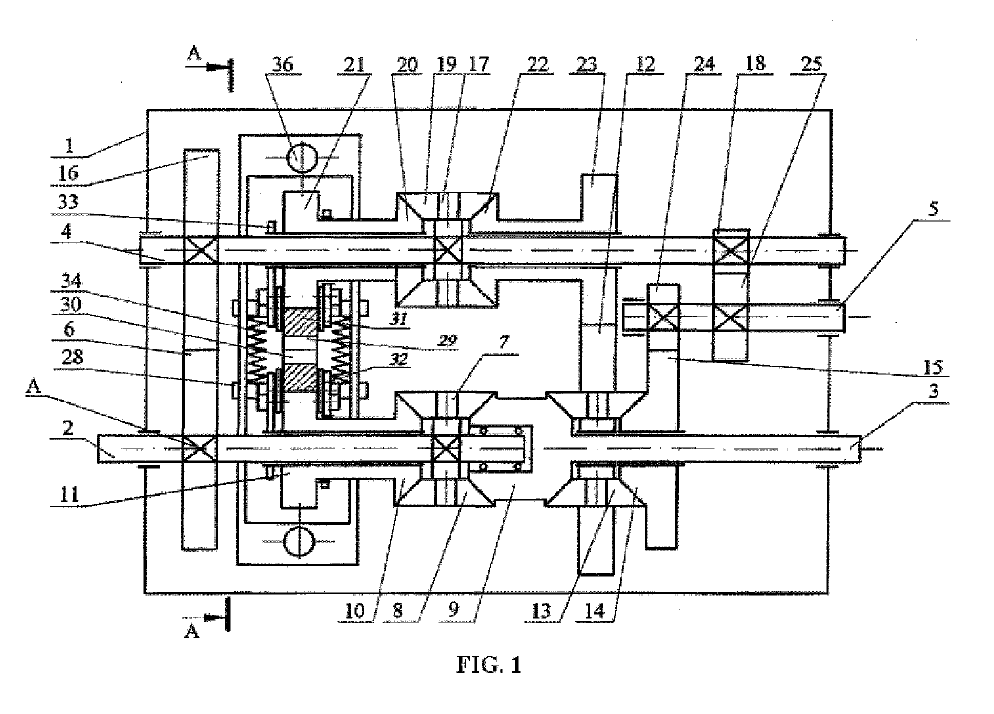

FIG. 2 is a sectional view along the line A-A in FIG. 1.

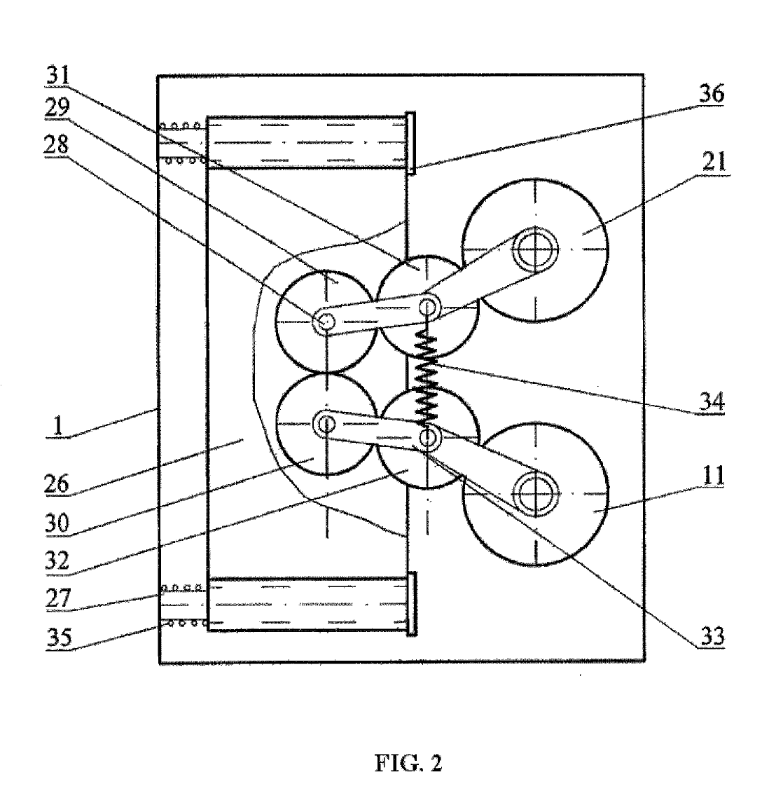

### DESCRIPTION OF THE PREFERRED EMBODIMENT OF THE INVENTION

The continuously variable torque transmission device comprises a housing 1 enclosing a drive shaft 2, driven shaft 3, countershaft 4, and an auxiliary shaft 5.

Drive shaft 2 has a gear 6 and a shaft 7 of differential pinions extending normally to shaft 2, both fitted rigidly thereon, the ends of shaft 7 being provided with two bevel wheels 8 engaging a pair of bevel wheels 9 and 10, one of which, wheel 10 on the left, being connected rigidly to a wheel 11 and the other, wheel 9 on the right, having gear rings on both sides thereof, being fitted rigidly on driven shaft 3.

A spur wheel 12 is fitted freely on driven shaft 3 and serves simultaneously as the shaft of differential pinions, with two bevel wheels 13 fitted thereon in engagement with the pair of bevel wheels 9 and 14. Wheel 14 is connected rigidly to gearwheel 15.

A gearwheel 16 in engagement with gear 6, shaft 17 of the differential pinions, and a gearwheel 18 are fitted rigidly on countershaft 4. Two spur wheels 19 in engagement with bevel wheels 20 and 22 are fitted on shaft 17. Bevel wheel 20 is connected rigidly to gearwheel 21 that engages wheel 11 through gearwheels 31, 29, 30, and 32, and bevel wheel 22 is connected rigidly to gearwheel 23 that engages spur wheel 12.

Gearwheels 24 and 25 are fitted rigidly on auxiliary shaft 5. Gearwheel 24 is in engagement with gearwheel 15, and gearwheel 25 engages gearwheel 18. Base 26 of the mobile mechanism of flexible brakes for the gearwheels is provided on guides 27 that are secured rigidly to housing 1. Shafts 28 in base 26 support wheels 29 and 30 engaging one another. Pairs of wheels 29 and 31, 31 and 21, 30 and 32, and 32 and 11 are connected with one another by mobile intermediate plates 33 and also are in engagement with one another. The shafts of wheels 31 and 32 are connected by springs 34. Springs 35 are provided on guides 27 between housing 1 and base 26, and so are limiters 36.

The device operates as follows:

Torque generated by a power unit is applied to drive shaft 2. At point A, the torque diverges toward gear 6 and shaft 7 of the differential pinions. The rotation speed of gear 6, shaft 7 of the differential pinions, and countershaft 4 is equal to the rotation speed of drive shaft 2 because gear 6 and gearwheel 16 are identical. At the start of device operation when the external moment has a maximum value and wheel 9 is motionless, the torque is directed into the device interior. Shaft 7 of the differential pinions begins to roll the pinions, or gearwheels 8, over wheel 9 and, therefore, rotate wheels 10 and 11 twice as fast as drive shaft 2 on one side of the device. On the other side, gear 6 transmits the torque through wheel 16 to countershaft 4 and, therefore, to shaft 17 of the differential pinions and to wheel 18. In its turn, wheel 18 begins rotating wheel 14 through wheels 25, 24, and 15 in the opposite direction relative to the rotation of drive shaft 2. The dimensions of wheels 18, 25, 24, and 15 are used to select the starting gear ratio of the claimed device because it depends on the rotation speed of wheel 14. It is important that wheel 12 is twice as big as wheel 23, that wheel 11 has the same diameter as wheel 21, wheel 31 is identical to wheel 32, and wheel 29 is also identical to wheel 30. Wheel 14 begins rolling the differential pinions, or wheels 13, over wheel 9 and, therefore, rotate wheel 12 in the opposite direction relative to the rotation of drive shaft 2. Wheel 12 then transmits the torque to wheel 23 and, therefore, to wheel 22. When wheel 22 rotates in the opposite direction relative to the rotation of countershaft 4, shaft 17 of the differential pinions rolls the pinions, or wheels 19, over rotating wheel 22 and, therefore, causes wheels 20 and 21 to rotate at a speed more than twice as high as the rotation speed of countershaft 4. This produces a difference in the rotation speeds of wheels 21 and 11. For the response of the mobile mechanism of flexible brakes of the gearwheels to this difference to be understood, it is enough to consider the difference between the torques of wheels 21 and 11. Clearly, the torque is only generated by wheel 21, with wheels 31, 29, 30, 32, and 11 motionless. Wheel 11 remains motionless because it is restrained by wheel 9. In these conditions, the torque of wheel 21 pulls at wheel 31 together with intermediate plates 33 and turn wheel 29 slightly, and its rotation is transmitted to wheel 30. In turn, wheel 30 turns wheel 32 until springs 34 are tensioned to a maximum extent. Simultaneously, intermediate plates 33 straighten out and cause base 26 to move in a straight line toward housing 1 and compress springs 35. The mobile mechanism of flexible brakes can only absorb part of the torque. Therefore, wheel 22, 23, and 12 stop, while wheel 14 continues to move. At this moment, wheels 11 and 21 rotate twice as fast as drive shaft 2, springs 34 are tensioned, and springs 35 compressed. The torque is only directed to wheel 9 that starts rotating together with driven shaft 3 that changes the rotation speed of all the three differentials. Wheel 9 rotates twice as fast as wheel 14 in the opposite direction at what is the starting gear ratio of the claimed device. As the external moment decreases, the flexible brakes of the gearwheels apply pressure to the differential pinions, wheels 8 and 19, and, therefore, accelerate the rotation speed of wheels 9, 22, 23, and 12. The processes are reversed with an increase in the external moment. The flexible brakes of the gearwheels respond to any change in the external moment, and the gear ratio of the claimed device always conforms to the external moment.

The gear ratio between drive shaft 2 and driven shaft 3 varies continuously under the effect of normal forces with all the gearwheels of the device always in engagement.

The claimed mechanical transmission by engagement at variable gear ratios helps to continuously vary the gear ratios for torque transmission by one shaft engaging another to achieve the desired result. The present invention can be used to improve the technical characteristics of machines and mechanisms.

What is claimed is:

1. A continuously variable torque transmission device comprising a housing, a drive and driven shafts, a countershaft, and an auxiliary shaft, wherein the drive shaft has a gear and a shaft of differential pinions fitted rigidly thereon, the shaft of the differential pinions being normal to the drive shaft and having two bevel wheels fitted at the ends thereof in engagement with a pair of bevel wheels, one of which is connected rigidly to a spur wheel and the other, with gear rings on both sides thereof, is fitted rigidly on the driven shaft; the driven shaft also having a spur wheel fitted freely thereon and serving simultaneously as the shaft of the differential pinions that is provided with two spur wheels in engagement with a pair of bevel wheels, one of which is a bevel wheel having two gear rings and the other is connected rigidly to a large-diameter spur wheel; the countershaft has a spur wheel fitted rigidly thereof in engagement with a gear, the shaft of the differential pinions and a small-diameter spur wheel being normal to the countershaft; the ends of the shaft of the differential pinions are provided with two bevel gears in engagement with a pair of bevel wheels, one of which is connected rigidly with a spur wheel that is in engagement, through a mobile mechanism of flexible brakes of the gearwheels, with a similar wheel fitted on the drive shaft, and the other is connected rigidly to the spur wheel that is in engagement with the wheel serving as the shaft of the differential pinions; the auxiliary shaft has two spur wheels fitted rigidly thereon, one being a small-diameter wheel in engagement with a large-diameter wheel fitted on the driven shaft, and the other being a large-diameter wheel in engagement with the small-diameter wheel and being fitted on the countershaft; the mobile mechanism of the flexible brakes of the gearwheels has a base located on guides secured rigidly to the housing; the base has the shafts of two spur wheels secured therein in engagement with one another, one of the wheels engaging the most mobile spur wheel in engagement with the wheel fitted on the countershaft, the shafts of said wheels being connected to one another by movable intermediate plates, and the other wheel engaging the other most mobile spur wheel that is, in turn, in engagement with the wheel fitted on the drive shaft, and the shafts of said pairs of wheels are also connected by movable intermediate plates, the shafts of the most mobile wheels being connected with one another by tension springs; compression springs are provided on the guides between the housing and the base of the mobile mechanism of flexible brakes; and the guides are provided with limiters.
